(19) United States
(12) Patent Application Publication
(10) Pub. No.: US 2009/0038375 A1
(43) Pub. Date: Feb. 12, 2009

(54) PHOTOACOUSTIC FREE FIELD DETECTOR

(76) Inventors: Klaus BREUER, Aschau (DE); Andrew H. Kung, Taipei (TW); Andras Miklos, Stuttgart (DE); Judit Angster, Stuttgart (DE); Klaus Sedlbauer, Holzkirchen (DE)

Correspondence Address: GREENBLUM & BERNSTEIN, P.L.C., 1950 ROLAND CLARKE PLACE, RESTON, VA, 20191, US

(21) Appl. No.: 11/994,056

(22) PCT Filed: Jun. 26, 2006
(86) PCT No.: PCT/EP06/06131

§ 371 Date: Feb. 26, 2008

(30) Foreign Application Priority Data
Jun. 28, 2005 (DE) 10 2005 030 151.7

(51) Int. Cl. G01N 29/02

(52) U.S. Cl. 73/24.02

(57) ABSTRACT

The invention relates to a photoacoustic detector including an acoustically open measuring area which is not completely surrounded by a housing. The detector includes an arrangement for introducing excitation light into the measuring area, such that the excitation light can be absorbed by absorbent materials which are located in the measuring area and which are used to produce acoustic energy. The invention also relates to a detector which includes at least one acoustic sensor and an arrangement is provided in order to concentrate the acoustic energy, in order to reach a local maximum of the acoustic pressure on at least one position. The at least one sensor is arranged in the vicinity of the at least one position, whereon the local maximum of the produced acoustic pressure is present or can be produced. The invention also relates to an associated method.

### BACKGROUND OF THE INVENTION

1. Field of the Invention

The invention concerns a photoacoustic free field detector. With a photoacoustic detector of this kind even a small quantity of trace gases is to be detected in a simple manner without complex sampling.

2. Description of Background and Other Information

Photoacoustic detection takes place in that excitation light is absorbed by absorbent materials. As a result, heating takes place. The heating leads to an expansion, especially if gases are being heated. Here the heating of the gases can also take place indirectly, for example by means of heated solid particles that heat the ambient gas. If the heating and the resulting expansion take place sufficiently rapidly, sound is produced that can be detected with an acoustic sensor, such as a microphone. The detected sound is thus a measure of the energy absorbed that depends on the intensity of the excitation light and also on the kind and concentration of the absorbent materials.

Photoacoustic detectors that are designed as closed cells with transparent windows are known in the art. In detectors of this kind the actual photoacoustic detection takes place in an acoustic resonator. The air or gas in which the absorbent materials to be detected are present—usually one is dealing with trace gases—flows through the cell. This is normally effected using a pump. Here, so-called multipass arrangements are also known in the art, in which the excitation light passes through the photoacoustic measurement cell several times. The optically reflecting elements that are necessary for this purpose, usually mirrors, are arranged outside the measurement cell, so that in each pass the excitation light must pass through two windows. The excitation light is thus weakened and only a low level of signal amplification occurs. The absorption in the windows can also have the disadvantage that as a result of the absorption an undesirable photoacoustic background signal is produced; this is overlaid on the measurement signal and thus reduces the measurement sensitivity.

In alternative arrangements, in which the air or gas that is to be investigated flows through the measurement cell, the inlet and the outlet are designed to be open to the gas, but closed to the sound waves produced. With a measurement arrangement of this kind, however, it is not possible to carry out free field measurements, which give a better mapping of the actual loading of the air with the absorbent materials. This is because the outlets and inlets that are closed to the sound waves allow only an impeded supply of the air that is being investigated. Therefore, so-called acoustically open photoacoustic detectors have also been developed. In photoacoustic detectors of this kind, however, the sound pressure on the microphone engendered by the absorption is already so weakened that the measurement sensitivity is reduced in an undesirable manner.

From the summary of JP 62 272 153 A, a photoacoustic measurement arrangement with an open cell is known in the art. Here, a measurement cell and a reference cell are present, which are pressed onto the surface of a sample. In this manner, airtight areas are formed. Modulated light is introduced by means of a fiber for illumination of the sample. As a result, pressure waves are produced, which arrive at a microphone. The position of the microphone is adjustable.

From the summary of JP 05 196 448 A, a further open photoacoustic measurement cell is known in the art. Modulated light from an argon ion laser is guided through a quartz window onto a surface that is to be measured. The cycle frequency of the laser matches the frequency of natural vibrations of the measurement column. This enables measurement with a high sensitivity.

Also from the summary of JP 05 026 627 A, an open photoacoustic measurement cell is known in the art.

From the utility patent DE 296 17 790 U1, an open photoacoustic measurement cell for the assessment of the skin, in particular human skin, using a light conducting cable and a microphone, is known in the art. The measurement cell is distinguished by the fact that an open, non-resonant photoacoustic measurement chamber is provided. In addition to the microphone, the related amplifier is also fitted in the measurement cell. In order to hold the measurement cell on a part of the body without movement, two retaining arms are provided. One form of embodiment for the microphone is an electret microphone.

From U.S. Pat. No. 4,533,252, a portable measurement cell for the measurement of the photosynthesis activity of photosynthetically active tissue is known in the art. The measurement cell is fitted in a housing that is open at one end. An acoustic probe is arranged in this housing. The housing is applied on or over the photosynthetically active sample. Both a modulated, and also a continuously radiating, light source are provided, means being present to conduct both the modulated light and also the continuous light onto the sample.

From U.S. Pat. No. 4,688,942, a radial or azimuthal non-resonant photoacoustic through-flow measurement cell is known in the art, said cell operating without windows. In this manner the background signal produced by the window is eliminated. The cell is designed as a long tube. The length of the cell is 34×103 cm, distributed by the modulation frequency of the light source, and consists of a conducting material.

From the utility patent AT 006 894 U2, a measurement chamber for photoacoustic sensors for the continuous measurement of radiation-absorbent materials, in particular of radiation-absorbing particles in gaseous samples, is known in the art. It is provided with at least one inlet and at least one outlet for the samples. It has a tube section, through which the sample can flow in the longitudinal direction, and in which a microphone is arranged. Furthermore, at least one entry and exit station for the laser beam is provided aligned with the tube section. The entry and exit stations are in each case separated by a chamber from the measurement tube. In order to reduce the contamination of the windows as entry stations for the radiation, and to slow down the deposition of the particles of the measurement aerosol on the windows, two inlets are provided at the mutually opposing ends of the tube section, as is one outlet at a location centrally between the inlets. In this manner operation of the measurement cell at high sensitivity is possible over a long period of time.

From DE 33 22 870 A1, a photoacoustic measurement device for the continuous determination of the concentration of particles contained in a gas is known in the art. It has two measurement cells in parallel to one another through which the light of a laser passes. Gas without particles is supplied to the first measurement cell. A chopper is located in the optical path in front of each of the two measurement cells. Here, the first chopper is operated with a chopping frequency that corresponds to the resonance frequency of the first measurement cell, while the chopping frequency of the second chopper corresponds to the resonance frequency of the second measurement cell. With a measurement device of this kind it is, for example, possible to determine the particle proportion in exhaust gases, e.g. of vehicles.

### DESCRIPTION OF THE INVENTION

The present invention provides for an acoustically open photoacoustic-free field detector in which a sufficient sound pressure is present at the acoustic sensor. The invention furthermore provides a corresponding acoustic measurement method.

A photoacoustic detector is provided with an acoustically open measuring area not completely surrounded by a housing. In following description, a measuring area is to be understood as an area in which the sound pressure produced by the absorption can escape from the inlets and outlets, of relatively large embodiment, for the sample air.

This photoacoustic detector includes an arrangement for the introduction of excitation light into the measuring area so that the excitation light can be absorbed by the absorbent materials located in the measuring area with the production of acoustic energy. Furthermore, at least one acoustic sensor is provided. The detector is distinguished by the fact that an arrangement for the concentration of the acoustic energy is present. With these arrangements, a local maximum of the sound pressure can be achieved at least at one position. Here, a local maximum of the sound pressure is to be understood as a position at which the sound pressure is perceptibly increased in comparison to the immediate environment. The at least one acoustic sensor is then arranged in the vicinity of the at least one position at which the local maximum of the sound pressure produced is present or can be produced. The concentration of the sound pressure produced enables measurements also to be taken in an acoustically open measuring area with sufficient sensitivity. In this manner, the above-described advantages of photoacoustic detectors with acoustically open measuring area are achieved, without, however, having to accept an undesirable reduction of the sound pressure at the acoustic sensor.

Although the foregoing description has been of air samples, because the main area of application is undoubtedly in the measurement of trace gases or particles in air or a gas mixture, it is also conceivable to use a photoacoustic free field detector for the measurement of liquids. While the production of a sufficiently high sound pressure is more difficult in liquids than in gases, the photoacoustic measurement of absorbent materials in liquids is nevertheless known in the art, and has been found to be practical in tests.

A further enhancement of the photoacoustic signal obtained can be achieved if optically reflecting elements are so arranged that the excitation light can pass through the measuring area several times. In this case, a higher level of energy is absorbed, which then leads to a correspondingly higher level of sound production.

One possibility for the concentration of the acoustic energy consists in the provision of elements that influence the acoustic energy produced by the absorption of the excitation light such that at least one position can be achieved with a local maximum of the sound pressure. Thus the sound that has already been produced is appropriately managed.

For the concentration of the acoustic energy it is, however, also possible to provide elements that allow a distribution of the excitation light such that the acoustic energy produced by the excitation light has a distribution such that a concentration of the acoustic energy can take place. In this manner also, at least one position with a local maximum of the sound pressure can be achieved. The two methods, that is to say the concentration of sound already produced, and the distribution of the excitation light in such a manner that the sound produced itself tends to concentrate at certain positions as a result of the geometric arrangement, can be combined. Both variants allow a concentration of acoustic energy in an acoustically open measuring area.

Acoustic mirrors are suitable for the concentration of the acoustic energy. With these, the sound pressure produced can be managed such that positions with a local maximum of the sound pressure are achieved.

This is achieved in a particularly beneficial manner if the acoustic mirrors are designed as parabolic mirrors.

Optically reflecting elements are suitable for the distribution of the excitation light. Here, optical mirrors are particularly suitable.

It has proved to be beneficial to design the photoacoustic detector such that the excitation light can be distributed such that production of acoustic energy can be engendered in a circular and/or spiral and/or polygonal sub-area of the measuring area. With a distribution of the excitation light of this kind, positions are formed at which a local maximum of the sound pressure occurs.

As is usual in photoacoustics, a photoacoustic detector according to the invention can also be operated with pulsed and/or modulated excitation light. Here, it is logical to match the modulation frequency of the light pulses to a maximum sensitivity of the acoustic sensor. It is true that diode lasers that emit infrared radiation are modulated with a frequency up to multiples of 100 megahertz. On account of the limited diameter of the laser beams at these high frequencies, the latter cannot be used in photoacoustics. The frequency range from 100 kHz to 500 kHz is, however, suitable for photoacoustic measurements. It is possible to modulate both the intensity and also the wavelength of the excitation light.

Pulsed solid-state lasers are suitable for the operation of the detector with pulsed excitation light; these emit pulses with a duration from 10 to 50 ns. The time-wise profile of the pulses is approximately Gaussian. The absorption of the laser pulse by a gas leads to an acoustic pulse, whose profile corresponds with the time-wise variation of the exciting light pulse. A unipolar laser pulse thus engenders a bipolar acoustic pulse with approximately the same duration. Bipolar acoustic pulses of this kind are engendered in the whole of the area through which the radiation passes, insofar as absorbent materials are present. The total duration of the acoustic pulse beyond the laser pulse is proportional to the time that the acoustic pulse requires to propagate through the laser pulse. For an assumed beam diameter of the exciting laser pulse of 1 mm, the duration of the acoustic pulse can be estimated as 3 ps. The frequency spectrum of an acoustic pulse of this kind is approximately Gaussian around a peak frequency of 300 kHz.

Because for the photoacoustic detector according to the invention no resonator is present, it is not appropriate to match the repetition frequency of the light pulses and/or modulation frequency to a resonance frequency of the resonator. Rather, it is logical to match the repetition frequency of the light pulses and/or the modulation frequency of the light source to a maximum sensitivity of the acoustic sensor used.

A condenser microphone and/or an electret microphone with an upper frequency limit in the range from 50 to 100 kHz has proved to be a suitable and sensitive acoustic sensor.

A suitable design of the condenser and/or electret microphone ensues if with a repetition frequency of the excitation light of 1 to 10 kHz measurements can be made at a harmonic. For a microphone designed in this manner a maximum sensitivity of the microphone can be achieved by matching to the repetition frequency of the excitation light.

It is also possible to use an ultrasound sensor as an acoustic sensor. Here, it is quite conceivable to use an ultrasound sensor that is not matched over a wide range of frequencies. For example, it is possible to use an ultrasound sensor that is matched to frequency values such as 40 kHz and/or 80 kHz and/or 120 kHz. Ultrasound sensors of this kind can be obtained at a competitive price.

The photoacoustic detector described, and a method with which absorbent materials are detected using the photoacoustic detector, are well-suited for the monitoring of the air quality in internal spaces, in particular for the monitoring of air that is sucked into ventilation systems for internal spaces. This is because a wide range of measurements can be covered with photoacoustic detection for a very wide variety of absorbent materials that can be troublesome in internal spaces. For ventilation devices, it is furthermore necessary that complex sampling can be avoided, since rapid adaptation of the ventilation to the detected concentrations of contaminants is desirable.

### BRIEF DESCRIPTION OF THE DRAWINGS

An increased understanding of the invention can be facilitated from the following description, with reference to the attached drawings, and in which:

FIG. 1 illustrates a first view of an exemplary illustration of a photoacoustic detector of the invention;

FIG. 2 illustrates a second view of the exemplary illustration of a photoacoustic detector of FIG. 1;

FIG. 3 illustrates the photoacoustic detector of FIGS. 1 and 2, showing an exciting light beam being reflected several times; and

FIG. 4 illustrates a detail of an acoustic mirror of the detector of FIGS. 1 and 2.

### DETAILED DESCRIPTION OF THE ILLUSTRATED EMBODIMENT OF THE INVENTION

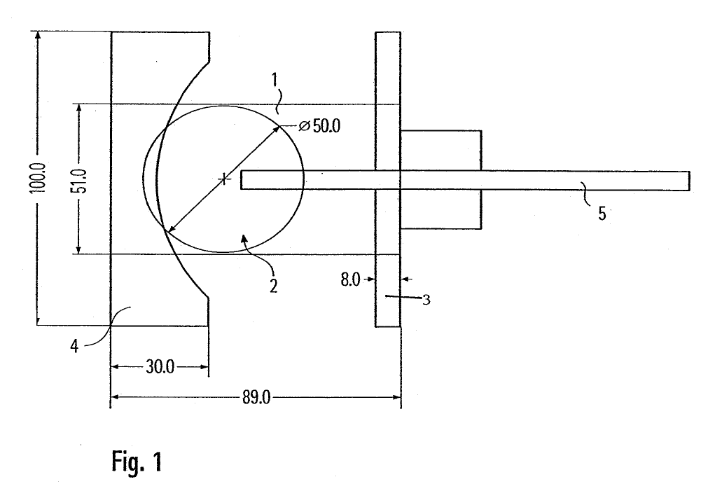

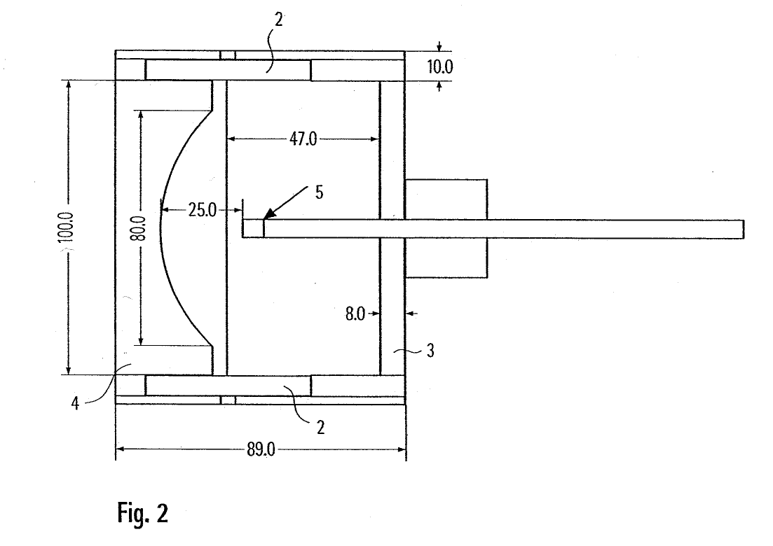

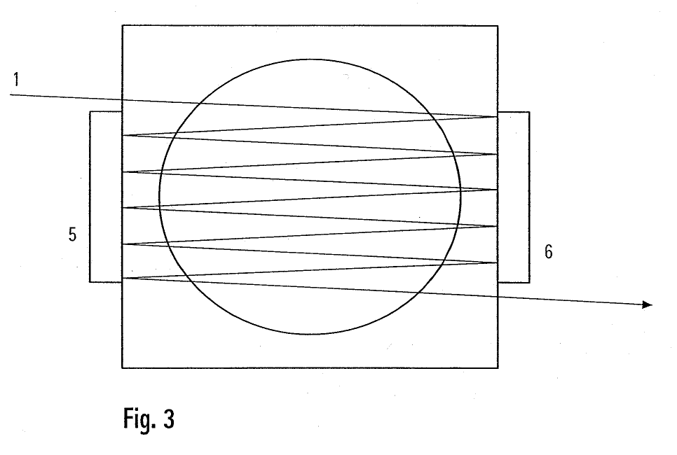

FIGS. 1 and 2 show an exemplary photoacoustic detector encompassed by the invention. The exciting light beam 1 of a laser, not represented, enters into the measuring area. By means of the two optical mirrors 2, which have a diameter of approximately 50 mm, the light is reflected several times. The reflected light beams are located in one plane (FIG. 3). Two acoustic mirrors 3, 4 are present. The first acoustic mirror 3 is a square flat mirror with a thickness of 8 mm and a side length of 100 mm. In its center it has a space for the microphone 5. The opposing second acoustic mirror 4 is square with a side length of 100 mm. In its outer area, the second acoustic mirror 4 has a thickness of 30 mm. In its inner area, which has a diameter of 80 mm, the second acoustic mirror is designed to be concave in the direction facing the measuring area. The microphone is located on the axis of symmetry of the acoustic mirrors. Here, the microphone 5 is at a distance of 25 mm from the second acoustic mirror 4.

FIG. 3 shows a structure in which the exciting light beam 1 passes through the measuring area several times. With each passage a certain proportion is absorbed, insofar as absorbent materials are present. The reflection of the light beam 1 takes place on the mirrors 2, which are designed as optical mirrors.

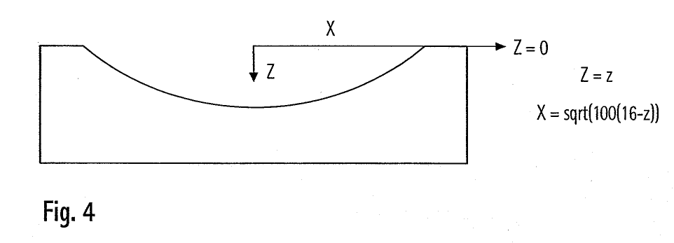

FIG. 4 shows a detail view of the second acoustic mirror 4. Here, the maximum depression is 16 mm. The radial distance from the center point of the second acoustic mirror 4 is denoted by X; the depth of the depression is denoted by z. The shape of the depression is then described by the following formula: X=sqrt (100*(16−z)).

1-14. (canceled)

15. A photoacoustic detector comprising:
an acoustically open measuring area not completely surrounded by a housing;
an arrangement to introduce excitation light into the measuring area so that the excitation light can be absorbed by absorbent materials located in the measuring area for the production of acoustic energy;
at least one acoustic sensor;
an arrangement for achieving a local maximum of sound pressure at at least one position;
the at least one acoustic sensor is arranged in the vicinity of the at least one position at which the local maximum of the sound pressure produced is present or can be produced.

16. A photoacoustic detector according to claim 15, wherein:
the arrangement to introduce excitation light into the measuring area comprises optically reflecting elements arranged so that the excitation light can pass several times through the measuring area.

17. A photoacoustic detector according to claim 15, wherein:
the arrangement for achieving a local maximum of sound pressure comprises elements provided to influence the acoustic energy produced by the absorption of the excitation light such that at least one position can be achieved with a local maximum of the sound pressure.

18. A photoacoustic detector according to claim 15, wherein:
the arrangement for achieving a local maximum sound pressure comprises acoustic energy elements provided to allow a distribution of the excitation light such that acoustic energy produced by the excitation light has a distribution such that a concentration of the acoustic energy can take place such that at least one position with a local maximum of the sound pressure can be achieved.

19. A photoacoustic detector according to claim 17, wherein:
the elements provided to influence the acoustic energy are acoustic mirrors.

20. A photoacoustic detector according to claim 19, wherein:
the acoustic mirrors are parabolic mirrors.

21. A photoacoustic detector according to claim 18, wherein:
optically reflecting elements, in the form of mirrors, are provided as the elements for the distribution of the excitation light.

22. A photoacoustic detector according to claim 18, wherein:
the excitation light can be distributed such that acoustic energy can be produced in a circular and/or spiral and/or polygonal sub-area of the measuring area.

23. A photoacoustic detector according to claim 15, wherein:
the excitation light can be introduced pulsed and/or modulated;
the repetition frequency of the light pulses and/or the modulation frequency can be matched to a maximum sensitivity of the at least one acoustic sensor.

24. A photoacoustic detector according to claim 15, wherein:
the acoustic sensor comprises a condenser microphone and/or an electret microphone having an upper frequency limit in the range from 50 to 100 kHz.

25. A photoacoustic detector according to claim 24, wherein:
the condenser and/or electret microphone has a repetition frequency of the excitation light of 1 to 10 kHz to measure at a harmonic.

26. A photoacoustic detector according to claim 15, wherein:
the acoustic sensor comprises an ultrasound sensor.

27. A method for photoacoustic detection of absorbent materials by using a detector according to claim 15.

28. A method of using the photoacoustic detector of claim 15 for monitoring air quality in internal spaces.

29. A method of using the photoacoustic detector of claim 15 for monitoring air quality of air sucked into a ventilation system for internal spaces.
